(19) United States
(12) Patent Application Publication
(10) Pub. No.: US 2026/0169909 A1
(43) Pub. Date: Jun. 18, 2026

(54) Methods And Systems For Asynchronous Copying Of Objects

(71) Applicant: Google LLC, Mountain View, CA (US)

(72) Inventor: Anup Talwalkar, Seattle, WA (US)

(21) Appl. No.: 18/980,098

(22) Filed: Dec. 13, 2024

(51) Int. Cl. G06F 12/02

(52) U.S. Cl. CPC G06F 12/023; G06F 2212/254

(57) ABSTRACT

The disclosed technology is directed to data object copying by separating copying of the metadata associated with the data object from copying of the actual data associated with the data object, and copying the metadata to the destination with a symbolic link to the source object. The symbolic link can provide a link to data that is yet to be copied. Upon completion of metadata copying, the system enables immediate object access through source redirection utilizing the symbolic links, while the actual object data transfer proceeds asynchronously in the background. If the user requests data that is not yet copied to the destination location, the system uses the symbolic link to access and retrieve the request data from the source location allowing access to the requested data.

### BACKGROUND

In cloud storage environments, copying objects between storage elements (sometimes referred to as buckets), particularly across different regions, often comes with significant performance challenges. An object, for example, may comprise a database object that represents a certain volume of data stored in a database in a given geographic region. Current synchronous copy operations are limited by cross-region bandwidth, often resulting in extended transfer times. Further, conventional object copy methods operate synchronously, requiring the entire data transfer to complete before confirming success to users (e.g., that the copy is available in the new region). This approach leads to poor user experience, especially when dealing with objects associated with large volumes of data or during periods of network congestion.

### BRIEF SUMMARY

Aspects of the disclosure are directed to apparatus, a system and a method for asynchronously copying data objects. The disclosed technology is directed to data object copying by separating copying of the metadata associated with the data object from copying of the actual data associated with the data object, and copying the metadata to the destination with a symbolic link to the source object. The symbolic link can provide a link to data that is yet to be copied. Upon completion of metadata copying, the system enables immediate object access through source redirection utilizing the symbolic links, while the actual object data transfer proceeds asynchronously in the background. As such, when metadata copying is complete, the system may provide feedback that copying is complete. If the user requests data that is not yet copied to the destination database, node or location, etc., the system uses the symbolic link to access and retrieve the request data from the source location allowing access to the requested data. This may avoid the hours, days or weeks when a user at times would have access to the data at a new region or location.

An aspect of the disclosure provides a method for copying data objects from a first storage element to a second storage element, the method including: receiving, by one or more processors, a request for copying data objects from the first storage element to the second storage element; generating, by the one or more processors, symbolic links associated with the data objects at the first storage element, the symbolic links providing a link to the data objects stored at the first storage element; copying, by the one or more processors, metadata for the data objects from the first storage element to the second storage element, the copied metadata comprising the symbolic links; and providing, by the one or more processors, a message indicating that the request for copying the data objects is completed when the copy of the metadata is completed.

In another example, the method further includes copying, by the one or more processors, the data objects associated with the request from the first storage element to the second storage element.

In yet another example, the method further includes placing a hold on the data objects associated with the request by generating information enabling the hold in the metadata in the first storage element.

In yet another example, the method further includes, after copying the data objects from the first storage element to the second storage element, releasing the hold on the one of the objects in the first storage element; and deleting the symbolic links in the copied metadata.

In yet another example, the symbolic links are pseudo symbolic links. In yet another example, copying the data objects from the first storage element to the second storage element is performed in a background after providing the message.

In yet another example, the method further includes receiving an access request for accessing one of the data objects associated with the request at the second storage element; identify metadata associated with the one of the data objects at the second storage element; determining presence of the symbolic link in the metadata associated with the one of the data objects; and using the symbolic link, retrieving bytes of the one of the data objects from the first storage element.

In yet another example, the method further includes retrieving bytes of the one of the data objects from the second storage element when the symbolic link is not present in the metadata associated with the one of the data objects.

In yet another example, the first and second storage elements are located in different geographic regions of a cloud computing network. In yet another example, copying the data objects includes copying the bytes of the objects to the second storage element based on available bandwidth.

Another aspect of the disclosure provides a system including: one or more processors; and one or more storage devices coupled to the one or more processors and storing instructions that, when executed by the one or more processors, cause the one or more processors to perform operations for copying data objects from a first storage element to a second storage element, the operations including: receiving, by one or more processors, a request for copying data objects from the first storage element to the second storage element; generating, by the one or more processors, symbolic links associated with the data objects at the first storage element, the symbolic links providing a link to the data objects stored at the first storage element; copying, by the one or more processors, metadata for the data objects from the first storage element to the second storage element, the copied metadata comprising the symbolic links; and providing a message indicating that the request for copying the data objects is completed when the copy of the metadata is completed. In another example, the method further includes copying, by the one or more processors, the data objects associated with the request from the first storage element to the second storage element.

In another example, the operations further include copying, by the one or more processors, the data objects associated with the request from the first storage element to the second storage element.

In yet another example, the operations further include placing a hold on the data objects associated with the request by generating information enabling the hold in the metadata in the first storage element.

In yet another example, the operations further include, after copying the data objects from the first storage element to the second storage element, releasing the hold on the one of the objects in the first storage element; and deleting the symbolic links in the copied metadata.

In yet another example, the symbolic links are pseudo symbolic links. In yet another example, copying the data objects from the first storage element to the second storage element is performed in a background after providing the message.

In yet another example, the operations further includes receiving an access request for accessing one of the data objects associated with the request at the second storage element; identify metadata associated with the one of the data objects at the second storage element; determining presence of the symbolic link in the metadata associated with the one of the data objects; and using the symbolic link, retrieving bytes of the one of the data objects from the first storage element.

In yet another example, the operations further include retrieving bytes of the one of the data objects from the second storage element when the symbolic link is not present in the metadata associated with the one of the data objects.

In yet another example, the first and second storage elements are located in different geographic regions of a cloud computing network. In yet another example, copying the data objects includes copying the bytes of the objects to the second storage element based on available bandwidth.

### BRIEF DESCRIPTION OF THE DRAWINGS

FIG. 1 depicts a block diagram of example systems of asynchronous copying of objects according to aspects of the disclosure.

FIG. 2 depicts a block diagram depicting an example structure of the source and destination metadata according to aspects of the disclosure.

FIG. 3 is a diagram depicting an example of the phases of a process of asynchronous copying of data objects according to aspects of the disclosure.

FIG. 4 depicts a flow diagram of an example process of asynchronous copying of objects according to aspects of the disclosure.

FIG. 5 depicts a block diagram of an example computing environment implementing an example process of asynchronous copying of objects according to aspects of the disclosure.

### DETAILED DESCRIPTION

Disclosed herein are systems and methods for asynchronously copying data objects from one system to another. A feature of the disclosed technology involves separating metadata copy operations from data copy operations for providing immediate access to the object through symbolic links established during the metadata copy operations.

The system for copying data objects can be configured to receive a copy request for data objects from a source storage element to a destination storage element. Upon receiving the request, the system can lock the data objects by establishing a temporary hold in the metadata associated with the data object for maintaining data consistency. The system can copy metadata associated with the data objects to the destination storage element. The copied metadata may include one or more symbolic links that include the source storage location information of the data objects associated with the copied metadata. When metadata copying is completed, the system can provide a response indicating the completion of the copy request and the actual object data transfer can proceed asynchronously in the background.

During the actual object data transferring, the system can provide immediate access to the data objects. When an access request for one of the objects is received at the destination storage location, the system can access the requested object directly from the destination storage location if the object has been copied. If the object has not yet been copied and remains in the source storage, the system can utilize a symbolic link to the source object to access the object data from the source location. Upon completion of the asynchronous actual object data transfer to the destination storage location, the system can remove the symbolic link and the temporary hold, thereby decoupling the source and destination objects.

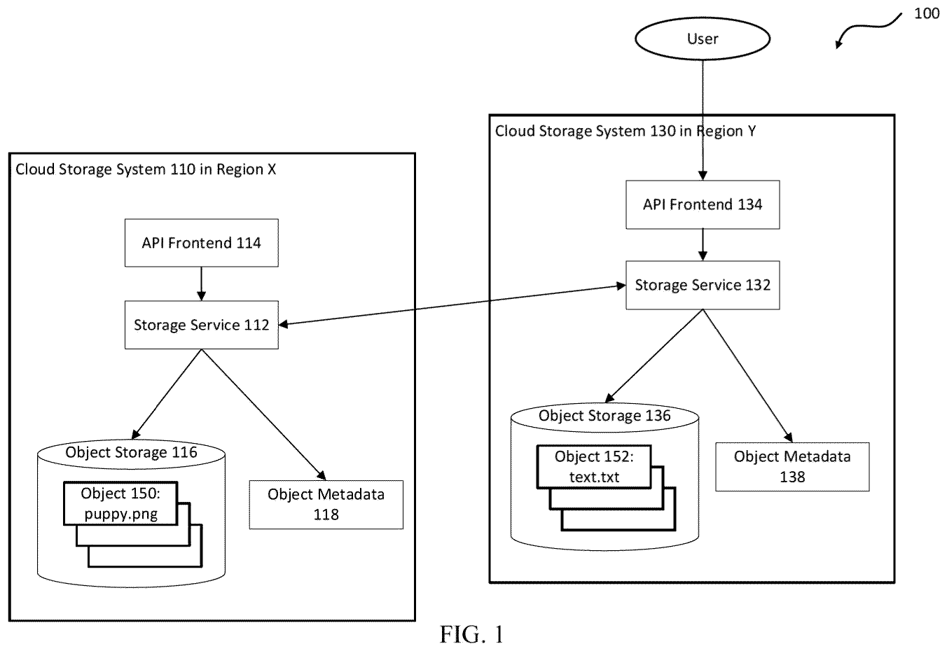

FIG. 1 depicts a block diagram of example systems 110, 130 according to aspects of the disclosure. The systems 110, 130 may be a single computer, multiple computers, or a distributed system as in a cloud environment. The systems 110, 130 for asynchronously copying data objects may include API frontends 114, 134, storage services 112, 132 and distributed storage systems 116, 136.

The API frontends 114, 134 can serve as the interface for data access, providing a standardized way for users to interact with stored objects. When a user sends a request, the API frontends 114, 134 can authenticate and validate the request before forwarding it to the appropriate storage services 112, 132. The storage service 114, 134 can then process these requests, managing all data operations including metadata handling, data transfer, request routing to correct storage regions, and protocol translations. The storage service 114, 134 ensures secure and efficient access to data objects while managing the underlying storage complexity, including cross-region operations and data consistency.

The systems 110, 130 can be the cloud storage systems that store data objects 150, 152 in the distributed object storage 116, 136. Cloud storage systems 110, 130 can be located in different regions, utilizing dedicated network connections for inter-region communication and data transfer. These storage systems 110, 130 communicate through secure, high-bandwidth channels while maintaining data consistency across regions.

The data objects 150, 152 are data consisting of a file of any format. Each data object has associated metadata 118, 138 that contains information, such as object size, creation timestamp, content type, access permissions, and version information. The metadata 118, 138 provide information about the data objects 150, 152. The metadata, for example, may include the location of the data to be copied, the location of the stored data, its size, etc. Both the data objects 150, 152 and their metadata 118, 138 can be stored in distributed object storage 116, 136 within each region's cloud storage infrastructure.

A system 130 can receive a copy request for objects from one storage location to another from the user. For instance, a copy request may be issued at region Y for copying one or more data objects 150 in region X to region Y. In general, with a copy request, a user may specify the destination location where the object will be copied to. Upon receiving the request, the system 130 can be configured to perform a metadata copy operation. First, the API frontend 134 can validate the copy request and forward it to the storage service 132. The storage service 134 can then process the copy request, copying the metadata of the source objects 118 from the source region X to the destination region Y. The storage service 134 can lock the source objects 150 by establishing a temporary hold on the metadata of the source objects 118. The storage service 134 can also generate symbolic links referencing the source objects stored in region X. The copied metadata 138 will typically include the generated symbolic links. In some examples, symbolic links are generated at the destination location or node 130. In other examples, the symbolic links may be generated at the source location or node 110 included in the metadata transfer from the source location to the destination location.

Once the metadata copy is complete, the system 130 can return a ‘SUCCESS’ response to the copy request. Once the success response is given to the user, the actual byte-level copy operation for copying the objects can occur in the background. During the background byte copy, a GET request for one of the objects can be received at region Y. When receiving a GET request for one of the objects, the system 130 can identify the location where the object is stored. For example, the API frontend 134 in region Y can fetch the requested object metadata and check if the metadata contains a symbolic link to the source. If a symbolic link is present in the metadata, indicating that the actual data resides in the source region, the API frontend 134 can forward the GET request to the storage service 132. The storage service 132 can perform a regional GET request to retrieve the bytes from the source region X and return them to the user. In some examples, the object is retrieved from the source region and returned to the user. In other examples, the object is returned by prioritizing copying the requested object to the destination location versus other copying taking place or set to take place. If no symbolic link is present in the metadata, indicating that the data has been copied in region Y, the storage service 132 can retrieve the bytes of the object locally from region Y.

The actual byte-level copy operation for copying the objects can occur asynchronously, decoupled from the initial copy request for the objects. The system 130 can be configured to transfer the data objects 150 from region X to region Y in the background while maintaining object accessibility. Upon completion of the asynchronous byte transfer to the destination region, the system 130 can remove both the symbolic link within the destination metadata 138 and the temporary hold within the source metadata 118, thereby decoupling the source and destination objects.

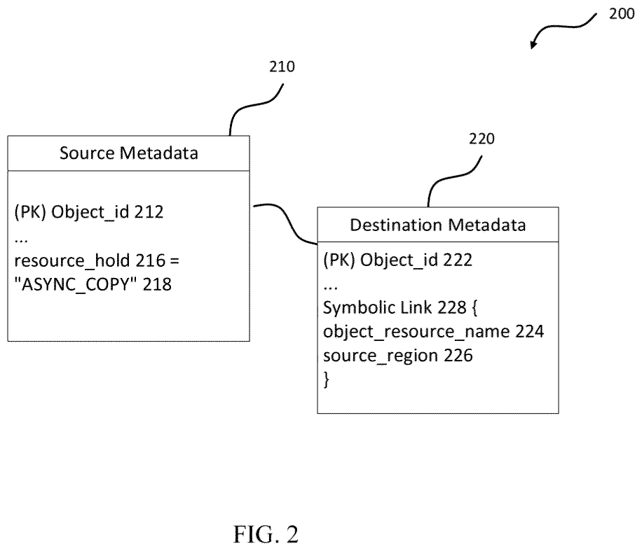

FIG. 2 illustrates an example structure 200 of the source and destination metadata. The source metadata 210 can include an Object ID 212, which serves as a primary key for queries, and entries such as resource hold 216. The resource hold 216 can be set on to ensure data consistency and include trigger information 218 indicating which operation triggered the temporary hold. The source data object can be locked by enabling the resource hold 216 with the trigger information before the actual data transfer is completed. This enables the system to copy objects to the destination region with data consistency, without modifying or deleting the source objects. The trigger information can be used to identify the purpose of the hold and enable proper cleanup once the copy operation is complete. The source metadata may be represented as follows:

```
Object_metadata {
  object_ID =
  . . .
  resource_hold = “ASYNC_COPY”
}
```

The destination metadata of data object 220 can also include an Object ID 222, which serves as a primary key for queries, and symbolic link entries 228. The symbolic link entries 228 can be generated and added to the destination metadata after copying the original metadata associated with the data object. The symbolic link entries 228, for example, can include the object resource name 224 and source region information 226. The object resource name 224 can include a URI with the name of project, bucket, object and version ID. The source region 226 can include the storage location information of where the objects are stored. The symbolic link entries 228 can establish the connection between the destination metadata and source objects, enabling references to the actual object. After actual object data copy is complete, the symbolic link entries 228 and resource hold entry 216 are removed from source and destination metadata 210 and 220 so that both source and destination metadata can be identical. The destination metadata may be represented as follows:

```
  Object_metadata {
    object_ID =
    . . .
  Symlink {
  object_resource_name=“project/<project_name>/bucket/<bucket_name>/
object/<object_name>”
  source_region = “region_x”;
    }
  }
```

The metadata can be copied to a destination when a data copy request is received, without copying the actual object. The time required for copying actual data objects can vary unpredictably depending on the object type, such as video, image, or raw data. However, the metadata can maintain a consistent size regardless of the actual object size, resulting in consistent processing time across all metadata operations. Therefore, the system can provide immediate response to users by sending a copy success message upon completion of metadata copy, which requires minimal processing time due to the consistent size and operation characteristics of metadata.

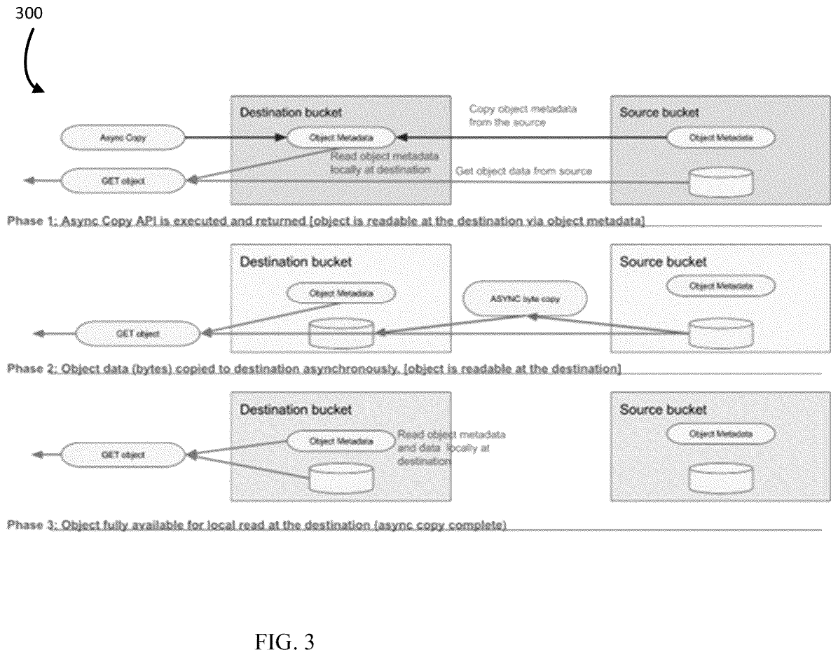

FIG. 3 illustrates examples of the phases of the process of asynchronous copying of objects according to aspects of the disclosure. Phase 1 can operate in constant time, focusing on metadata copy and initial setup. In Phase 1, the destination system can receive the copy request for the data objects, such as the query ‘Async COPY’. The destination system can begin with operations that establish a temporary hold on the source object by enabling the hold feature in the source metadata. The destination system can also generate symbolic links to the source objects for the destination metadata.

The symbolic link is the reference to the source data object. For example, the symbolic link can be implemented as a pseudo-symlink. The symbolic link can include the location information where the actual objects are stored. Upon completion of metadata copying and the addition of these entries to respective metadata the system can return a ‘SUCCESS’ response to the copy request, indicating the copy operation has been initiated.

Phase 2 can include the asynchronous object copy process. In accordance with this process, the destination system can initiate the asynchronous object copy process by copying the data object to the destination in the background. The actual copy operation of data objects may operate with variable timing, as its duration can depend on the object size, object type, and available bandwidth for byte copying. The initiation of actual copy may vary from seconds to hours depending on resource availability. The system can first queue the data copy operation, specifying the object name, source and destination regions, and target region information. The asynchronous object copy process can then proceed at a rate that the service can accommodate, taking into account network conditions and system resources.

During the asynchronous object copy process, the system can manage access requests to the data objects. Upon receiving an access request for a specific data object, such as the query ‘GET’, the system can identify the location where the object is stored. For this purpose, the destination system can retrieve and examine the object's metadata stored in the destination to verify the presence of a symbolic link. When the system identifies a symbolic link in the metadata, the system can determine that the actual data still resides in the source storage element. The system can then utilize the location information contained in the symbolic link to redirect the access request to the source storage element. The destination system can process this redirected request, retrieve the actual object data from the source location, and return it through the original access request path to the user. If the system determines that no symbolic link exists in the metadata, this can indicate that the object has already been copied to the destination, and the system can retrieve the object data directly from the local storage. This redirection process can enable continuous data access while the background copy operation proceeds.

In Phase 3, the system can focus on cleanup activities to complete the copy process, thereby decoupling the source and destination objects. During this final phase, as the actual data transfer of the target objects has been completed, these objects can be fully available for access at the destination storage, without requiring source redirection. Therefore, the system can perform asynchronous cleanup operations to decouple the source and destination objects. The system can remove the previously established symbolic link to the source object. Additionally, at the source location, the temporary hold that was protecting the source object from deletion can be removed. This cleanup phase can ensure that both objects become fully independent, completing the copy process.

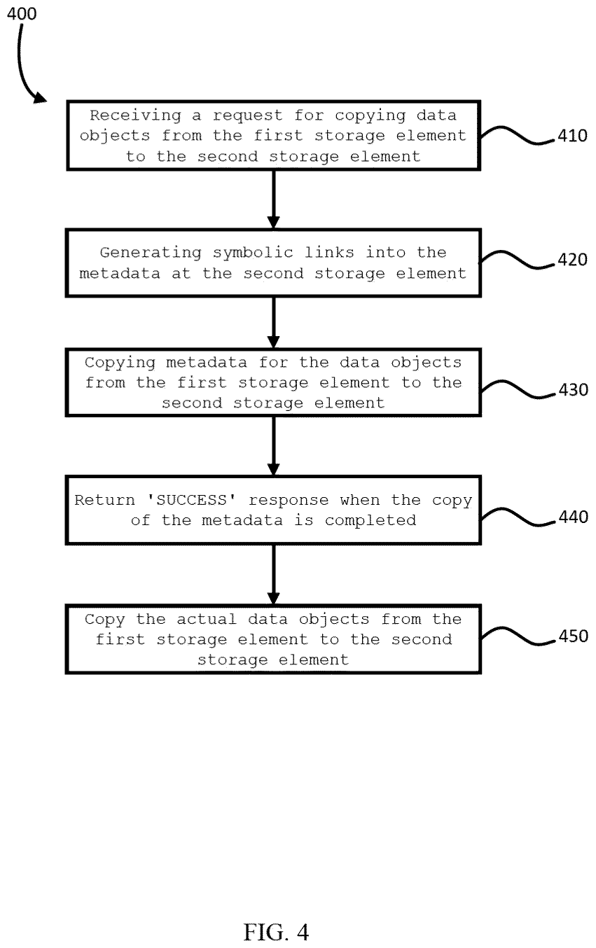

FIG. 4 depicts flow diagrams of an example process 400 of asynchronous copying of objects according to aspects of the disclosure. The example process 400 can be performed on the system 130 described in FIG. 1. While the operations are described in a particular order below, the order may be modified, and operations may be performed in parallel. Moreover, operations may be added or omitted.

As shown in block 410, the system can receive a copy request for copying data objects from the first storage element to the second storage element. The objects can be in any format such as photos, audio files, network logs, emails, and can vary in size. The plurality of objects may exist in any data storage, such as a system outside of cloud storage.

As shown in block 420, the system can generate symbolic links. The symbolic links can provide a link to the data objects stored at the first storage element, including the location information where the associated actual object data is stored. As shown in block 430, the system can copy metadata for the data objects from the first storage element to the second storage element. The copied metadata can include the generated symbolic links. As shown in block 440, the system can provide a message indicating that the request for copying the data objects is completed when the metadata copy is completed. The system can return a ‘SUCCESS’ response at this point.

As shown in block 450, the system can initiate copying the actual data objects from the first storage element to the second storage element. This copy operation can occur at variable times depending on the object type, size, and available bandwidth, with the system determining optimal timing for the transfer based on resource availability.

During this process, when the second storage element receives an access request for one of the objects, the system can examine the object's metadata. If a symbolic link exists in the metadata, the system can redirect the request to the source location to access the original object. If no symbolic link is found in the metadata, the system can access the object locally at the second storage element.

Upon completion of copying the actual data objects from the first storage element to the second storage element, the system can remove both the symbolic link and the temporary hold on the source object, thereby decoupling the source and destination objects.

Throughout these operations, the system can maintain data consistency while providing immediate access to the object through the redirect mechanism established during the metadata copy phase. This approach can allow users to begin accessing the copied objects immediately after metadata copy completion, without waiting for the actual data objects to be copied. The actual data transfer can occur transparently in the background, and the process can be completed with cleanup operations.

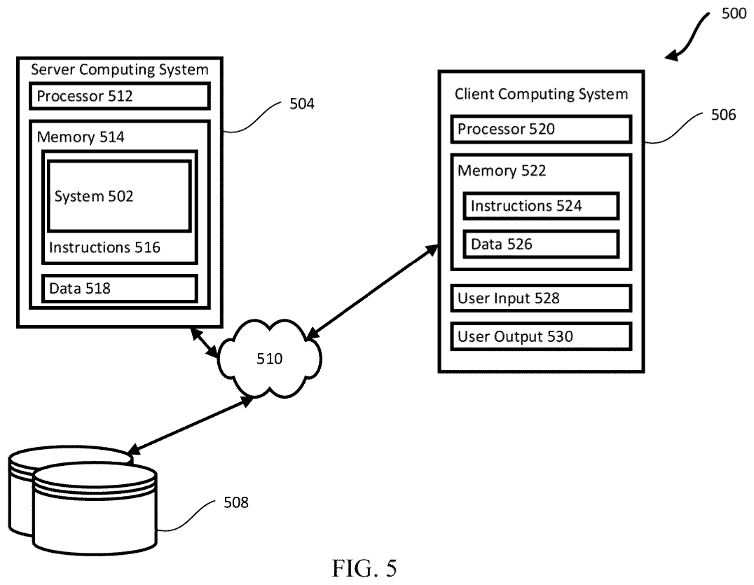

FIG. 5 depicts a block diagram of an example computing environment 500 implementing an example server computing system 504. The system can be implemented through the system, which provides tools and environments to implement and run the system. For example, the server computing system 504 can be the system 130 described in FIG. 1. The server computing system 504 can be implemented on one or more devices having one or more processors in one or more locations, such as in server computing device 504. The system can include one or more AI/ML engines, modules, or models. The AI/ML engines, modules, or models can be implemented as one or more computer programs, specially configured electronic circuitry, or any combination thereof. The AI/ML engines, modules, or models can be configured to create and control bookmarks for datasets used to select for training ML models.

User computing system 506 and the server computing device 504 can be communicatively coupled to one or more storage devices 508 over a network 510. The storage devices 508 can be the distributed object storage 116, 136 described in FIG. 1. The storage devices 508 can be a combination of volatile and non-volatile memory and can be at the same or different physical locations than the computing systems 504, 506. For example, the storage device(s) 508 can include any type of non-transitory computer readable medium capable of storing information, such as a hard-drive, solid state drive, tape drive, optical storage, memory card, ROM, RAM, DVD, CD-ROM, write-capable, and read-only memories. Cloud storage is a mode of computer data storage in which digital data is stored on one or more storage devices 508 over a network 510.

The server computing device 504 can include one or more processors 512 and memory 514. The memory 514 can store information accessible by the processors 512, including instructions 516 that can be executed by the processors 512. The memory 514 can also include data 518 that can be retrieved, manipulated, or stored by the processors 512. The memory 514 can be a type of transitory or non-transitory computer readable medium capable of storing information accessible by the processors 512, such as volatile and non-volatile memory. The processors 512 can include one or more central processing units (CPUs), graphic processing units (GPUs), field-programmable gate arrays (FPGAs), and/or application-specific integrated circuits (ASICs), such as tensor processing units (TPUs).

The instructions 516 can include one or more instructions that, when executed by the processors 512, cause the one or more processors 512 to perform actions defined by the instructions 516. The instructions 516 can be stored in object code format for direct processing by the processors 512, or in other formats including interpretable scripts or collections of independent source code modules that are interpreted on demand or compiled in advance. The instructions 516 can include instructions for implementing server computing system 504. The server computing system 504 can be executed using the processors 512, and/or using other processors remotely located from the server computing device 504.

The data 518 can be retrieved, stored, or modified by the processors 512 in accordance with the instructions 516. The data 518 can be stored in computer registers, in a relational or non-relational database as a table having a plurality of different fields and records, or as JSON, YAML, proto, or XML documents. The data 518 can also be formatted in a computer-readable format such as, but not limited to, binary values, ASCII or Unicode. Moreover, the data 518 can include information sufficient to identify relevant information, such as numbers, descriptive text, proprietary codes, pointers, references to data stored in other memories, including other network locations, or information that is used by a function to calculate relevant data.

The user computing system 506 can also be configured similar to the server computing device 504, with one or more processors 520, memory 522, instructions 524, and data 526. The user computing system 506 can also include a user input 528, and a user output 530. The user input 528 can be the user described in FIG. 1 and include any appropriate mechanism or technique for receiving requests for copying or accessing data objects from a user, such as keyboard, mouse, mechanical actuators, soft actuators, touchscreens, microphones, and sensors.

The server computing device 504 can be configured to transmit data to the user computing system 506, and the user computing system 506 can be configured to display at least a portion of the received data on a display implemented as part of the user output 530. The user output 530 can also be used for displaying an interface between the user computing system 506 and the server computing device 504. The user output 530 can alternatively or additionally include one or more speakers, transducers or other audio outputs, a haptic interface or other tactile feedback that provides non-visual and non-audible information to the user of the user computing system 506.

Although FIG. 5 illustrates the processors 512, 520 and the memories 514, 522 as being within the computing systems 504, 506, components described herein, including the processors 512, 520 and the memories 514, 522 can include multiple processors and memories that can operate in different physical locations and not within the same computing device. For example, some of the instructions 516, 524 and the data 518, 526 can be stored on a removable SD card and others within a read-only computer chip. Some or all of the instructions 516, 524 and data 518, 526 can be stored in a location physically remote from, yet still accessible by, the processors 512, 520. Similarly, the processors 512, 520 can include a collection of processors that can perform concurrent and/or sequential operations. The computing systems 504, 506 can each include one or more internal clocks providing timing information, which can be used for time measurement for operations and programs run by the computing systems 504, 506.

The server computing device 504 can be configured to receive requests to process data from the user computing system 506. For example, the environment 500 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing system 506 may receive and transmit data specifying target computing resources to be allocated for executing a neural network trained to perform a particular neural network task.

The computing systems 504, 506 can be capable of direct and indirect communication over the network 510. The computing systems 504, 506 can set up listening sockets that may accept an initiating connection for sending and receiving information. The network 510 can include various configurations and protocols including the Internet, World Wide Web, intranets, virtual private networks, wide area networks, local networks, and private networks using communication protocols proprietary to one or more companies. The network 510 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 510, in addition or alternatively, can also support wired connections between the computing systems 504, 506, including over various types of Ethernet connection.

Although a single server computing device 504 and user computing systems 506 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for copying data objects from a first storage element to a second storage element, the method comprising:
receiving, by one or more processors, a request for copying data objects from the first storage element to the second storage element;
generating, by the one or more processors, symbolic links associated with the data objects at the first storage element, the symbolic links providing a link to the data objects stored at the first storage element;
copying, by the one or more processors, metadata for the data objects from the first storage element to the second storage element, the copied metadata comprising the symbolic links;
and
providing, by the one or more processors, a message indicating that the request for copying the data objects is completed when the copy of the metadata is completed.

2. The method of claim 1, the method further comprising copying, by the one or more processors, the data objects associated with the request from the first storage element to the second storage element.

3. The method of claim 1, the method further comprising placing a hold on the data objects associated with the request by generating information enabling the hold in the metadata in the first storage element.

4. The method of claim 3, the method further comprising:
after copying the data objects from the first storage element to the second storage element, releasing the hold on the one of the objects in the first storage element; and
deleting the symbolic links in the copied metadata.

5. The method of claim 1, wherein the symbolic links are pseudo symbolic links.

6. The method of claim 2, wherein copying the data objects from the first storage element to the second storage element is performed in a background after providing the message.

7. The method of claim 1, the method further comprising:
receiving an access request for accessing one of the data objects associated with the request at the second storage element;
identify metadata associated with the one of the data objects at the second storage element;
determining presence of the symbolic link in the metadata associated with the one of the data objects; and
using the symbolic link, retrieving bytes of the one of the data objects from the first storage element.

8. The method of claim 7, the method further comprising: retrieving bytes of the one of the data objects from the second storage element when the symbolic link is not present in the metadata associated with the one of the data objects.

9. The method of claim 1, wherein the first and second storage elements are located in different geographic regions of a cloud computing network.

10. The method of claim 2, wherein copying the data objects comprises copying the bytes of the objects to the second storage element based on available bandwidth.

11. A system comprising:
one or more processors; and
one or more storage devices coupled to the one or more processors and storing instructions that, when executed by the one or more processors, cause the one or more processors to perform operations for copying data objects from a first storage element to a second storage element, the operations comprising:
receiving, by one or more processors, a request for copying data objects from the first storage element to the second storage element;
generating, by the one or more processors, symbolic links associated with the data objects at the first storage element, the symbolic links providing a link to the data objects stored at the first storage element;
copying, by the one or more processors, metadata for the data objects from the first storage element to the second storage element, the copied metadata comprising the symbolic links; and
providing a message indicating that the request for copying the data objects is completed when the copy of the metadata is completed.

12. The system of claim 11, wherein the operations further comprising copying the data objects associated with the request from the first storage element to the second storage element.

13. The system of claim 11, wherein the operations further comprising placing a hold on the data objects associated with the request by generating information enabling the hold in the metadata in the first storage element.

14. The system of claim 13, wherein the operations further comprising:
after copying the data objects from the first storage element to the second storage element, releasing the hold on the one of the objects in the first storage element; and
deleting the symbolic links in the copied metadata.

15. The system of claim 11, wherein the symbolic links are pseudo symbolic links.

16. The system of claim 11, wherein copying the objects from the first storage element to the second storage element is performed in a background after sending the message.

17. The system of claim 10, wherein the operations further comprising:
receiving an access request for accessing one of the data objects associated with the request at the second storage element;
identify metadata associated with the one of the data objects at the second storage element;
determining presence of the symbolic link in the metadata associated with the one of the data objects; and
using the symbolic link, retrieving bytes of the one of the data objects from the first storage element.

18. The method of claim 17, the operations further comprising: retrieving bytes of the one of the data objects from the second storage element when the symbolic link is not present in the metadata associated with the one of the data objects.

19. The system of claim 11, wherein the first and second the request for copying the data objects is completed are located in different geographic regions of a cloud computing network.

20. The system of claim 11, wherein copying the data objects comprises copying the bytes of the objects to the second storage element based on available bandwidth.
